(19) United States
(12) Patent Application Publication
(10) Pub. No.: US 2009/0107100 A1
(43) Pub. Date: Apr. 30, 2009

(54) CUSHIONED SWING CYLINDER FOR AGRICULTURAL MOWER

(76) Inventors: Shane A. Bollinger, Leighton, IA (US); Calvin D. Meinders, Pella, IA (US)

Correspondence Address: STURM & FIX LLP, 206 SIXTH AVENUE, SUITE 1213, DES MOINES, IA, 50309-4076, US

(21) Appl. No.: 11/928,224

(22) Filed: Oct. 30, 2007

(51) Int. Cl. A01D 67/00

(52) U.S. Cl. 56/218

(57) ABSTRACT

A swing cylinder such as those used to offset an agricultural implement may experience larges forces as it reaches the ends of its travel. A cushioning system to mitigate these forces comprises a piston with wear rings engaged thereto. The wear rings block off a usual passageway for the hydraulic fluid to flow, and provide their own, much smaller passageway. The flow of hydraulic fluid is thereby restricted in the neighborhood of the extremes of piston travel. An additional aspect of the invention is that the wear rings are pushed out of their position blocking the passageway when hydraulic fluid pressure is applied to move the piston away from the extreme position, thereby completely removing the restriction to flow in that direction.

### CROSS REFERENCE TO RELATED APPLICATIONS

U.S. patent application Ser. No. 11/927,866 filed Oct. 30, 2007 (Our Reference 2-5169-110), U.S. patent application Ser. No. 11/928,010 filed Oct. 30, 2007 (Our Reference 2-5169-111) and U.S. patent application Ser. No. 11/928,082 filed Oct. 30, 2007 (Our Reference 2-5169-112) are hereby incorporated by reference herein in their entirety.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates generally to a mower used in agricultural applications. More particularly, the present invention relates to an improved swing cylinder used in appropriately orienting a tongue of an agricultural mower for transport and for mowing.

2. Background Art

Some agricultural implements, notably mowers and mower-conditioners, require that the implement be offset from the tractor when in operation so the tractor does not knock down crop before it can be processed, and also that the implement be centerable behind the tractor for transport. The use of a hydraulic swing cylinder is known in the prior art. In U.S. Pat. No. 7,047,714, a swing cylinder arrangement is disclosed providing the ability to both offset a mower-conditioner for operation and center the mower-conditioner behind the tractor for transport.

Another swing cylinder is disclosed in U.S. Pat. No. 6,907,719. The swing cylinder is shown in FIGS. 3-5 in U.S. Pat. No. 6,907,719 denoted with reference numeral 7.

As an agricultural implement tongue is rotated about a pivot axis, the swing cylinder retracts or extends depending on the direction of rotation. The maximum and minimum angle the tongue can be positioned relative to the frame is thereby determined by the stroke range of the cylinder. The cylinder is pivotally mounted to the frame at a pivot point which is not coincident with the pivot point of the tongue, but offset in a transverse direction and possibly in the longitudinal direction. Abrupt deceleration at the extreme ends of the swing cylinder's stroke can be significant. Dynamic forces resulting from the rotation of the tongue can be sufficient to cause structural damage to the tongue, frame, or swing cylinder when the cylinder reaches its maximum or minimum stroke.

There is, therefore, a need for a method and apparatus to reduce the magnitude of the deceleration at the extreme ends of the swing cylinder's stroke to reduce dynamic forces and consequent damage.

### BRIEF SUMMARY OF THE INVENTION

An object of the present invention is to provide a swing cylinder, for tongued agricultural implements, for which stroke speed is restricted at the extreme ends of its stroke in the direction of the extreme ends. Another object is, then, when traveling away from the extreme ends, the cylinder's stroke speed is not limited, even when the hydraulic cylinder position is at an extreme.

To effect the instant invention, wear rings are provided at each end of a piston about the hydraulic swing cylinder ram. These wear rings are permitted to slide in an axial direction due to forces encountered when the piston is moving axially. When the piston approaches either extreme end of its travel, the wear rings pass the port at that extreme end. Passageways are provided in the piston through which hydraulic fluid may pass. Additionally, splits are provided in the wear rings. The hydraulic fluid may pass from the passageways in the piston, through the splits in the wear ring in order to exit the port. The split in the wear rings is very small, and presents a significant restriction to the flow of hydraulic fluid. Hence, the flow rate of the hydraulic fluid is reduced, consequently reducing the cylinder's stroke speed.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of a center pivot mower of the present invention having a tongue pivotally connected to the frame with a relative angle controlled by a swing cylinder;

FIG. 2 is a top plan view of the center pivot mower with the mower swung in a first direction for operation;

FIG. 3 is a top plan view of the center pivot mower with the mower swung in a second direction for operation;

FIG. 4 is a top plan view of the rear of the center pivot mower;

FIG. 5 is a geometric schematic of the mower from the top showing the tongue at a minimum, maximum, and perpendicular angle to the frame;

FIG. 6 is a first cross sectional view of the cushioned swing cylinder in an extended position;

FIG. 7 is a second cross sectional view of the cushioned swing cylinder in a retracted position;

FIG. 8 is a third cross sectional view of the cushioned swing cylinder in a midpoint position;

FIG. 9 is a first detail of the cross section of a piston within the swing cylinder with wear rings;

FIG. 10 is a second detail of the cross section of the piston with wear rings;

FIG. 11 is a detail view of the piston and lower wear ring in the vicinity of a hydraulic fluid port;

FIG. 12a is a perspective view of a wear ring exhibiting a first form of a split;

FIG. 12b is a perspective view of a wear ring exhibiting a second form of a split;

FIG. 12c is a perspective view of a wear ring exhibiting orifices for the passage of hydraulic fluid;

FIG. 13 is a plan view showing the piston, cylinder ram, and passages;

FIG. 14a shows a hydraulic piston in a first position relative to an extreme end of travel, the hydraulic cylinder tube having a variable inside diameter;

FIG. 14b shows the hydraulic piston in a second position relative to the extreme end of travel, the hydraulic cylinder tube having a variable inside diameter; and

FIG. 14c shows the hydraulic piston at the extreme end of travel, the hydraulic cylinder tube having a variable inside diameter.

### DETAILED DESCRIPTION OF THE INVENTION

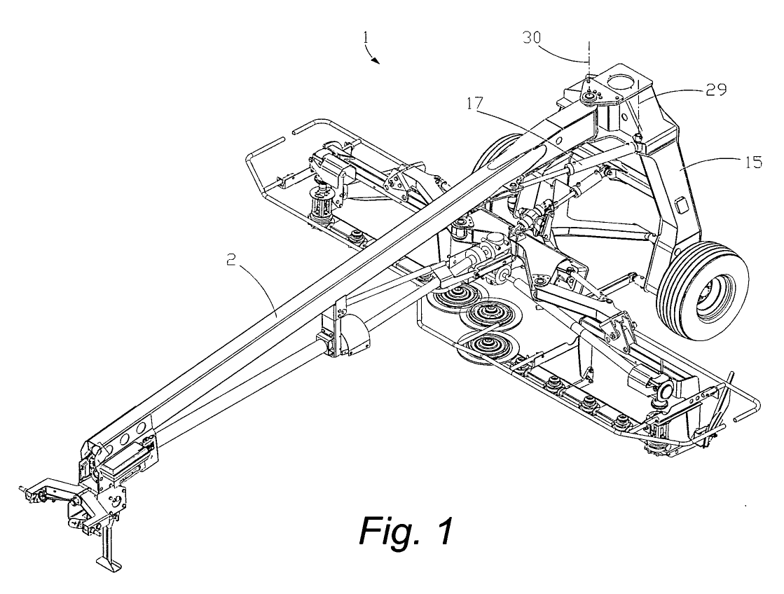

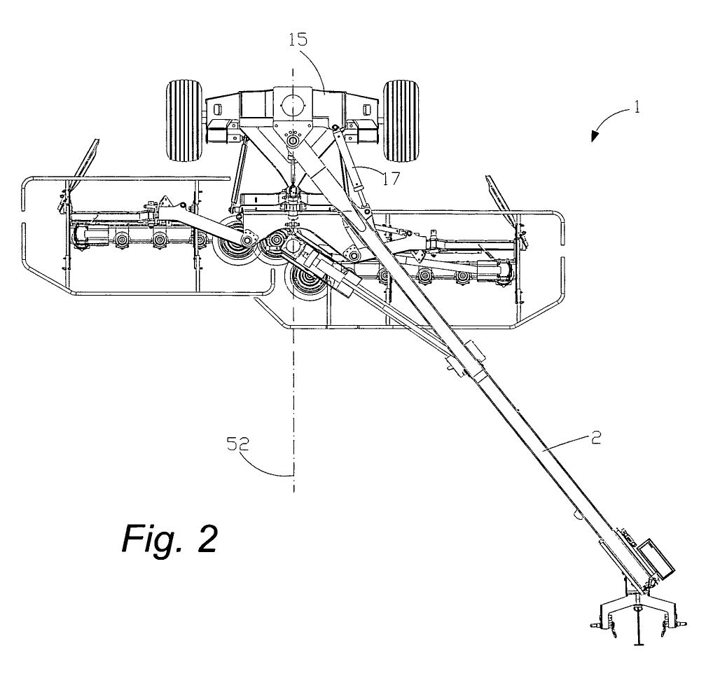

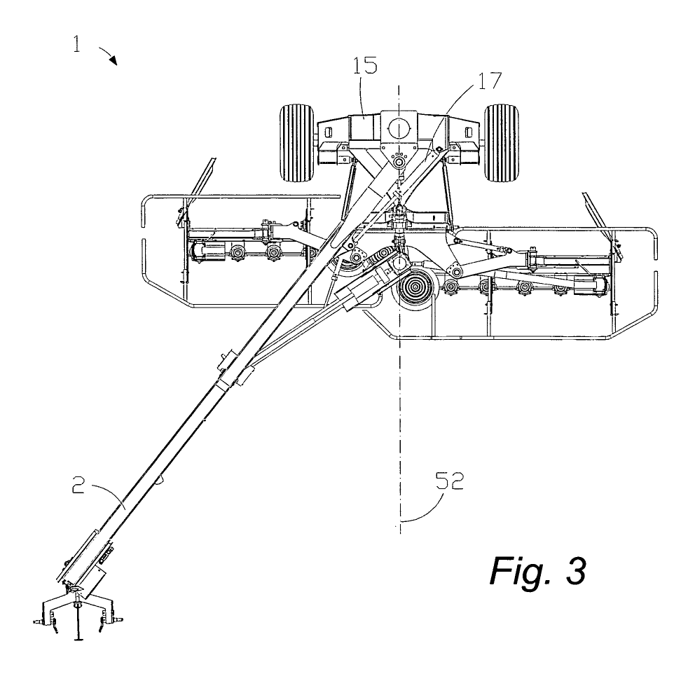

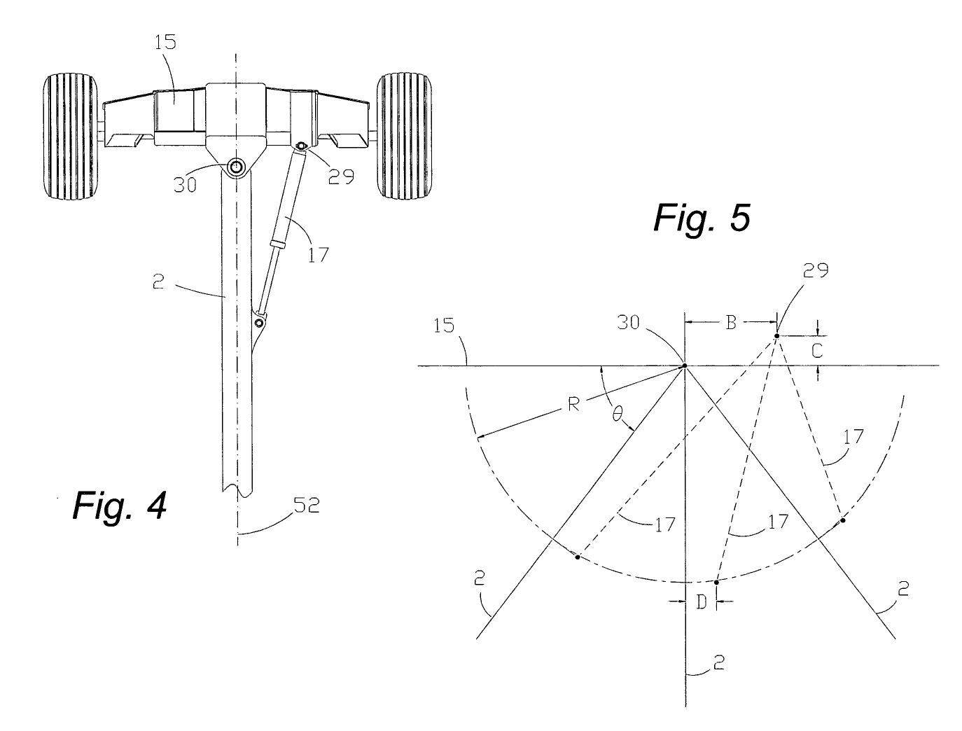

Referring now to the drawings wherein like reference numerals correspond to the same or similar parts throughout the drawings, the present invention makes use of a cushioned cylinder as a swing cylinder 17, as seen in all the figures, on a center-pivot agricultural mower 1. As shown in FIGS. 1-5, the swing cylinder 17 controls the rotation of a tongue 2 about a vertical axis 30 such that the tongue 2 can be positioned at a variable angle, θ, relative to a mower frame 15 on either side of a centerline 52 of the agricultural mower 1. The way θ is measured is illustrated in FIG. 5.

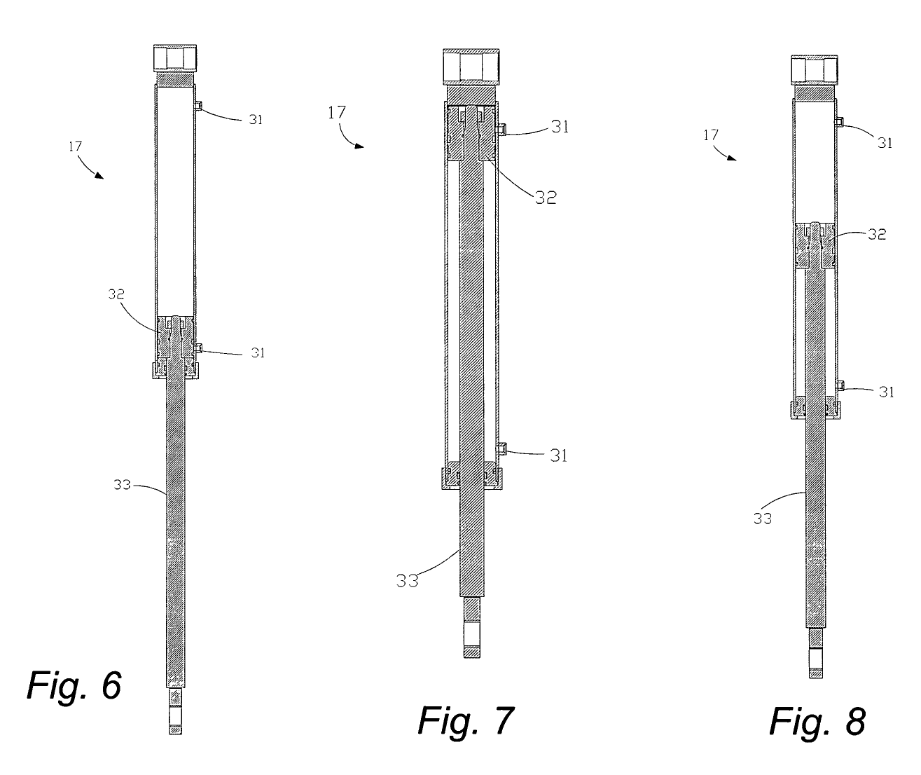

As the tongue 2 is rotated about the pivot axis 30, the swing cylinder 17 retracts or extends depending on a direction of rotation. The maximum and minimum angle, θ=θₘₐₓ, the tongue 2 can be positioned relative to the frame 15 is thereby determined by a stroke range (compare FIGS. 6 and 7) of the cylinder 17. Dynamic forces resulting from the rotation of the tongue 2 can be sufficient to cause structural damage to the tongue 2 and/or frame 15 when the cylinder 17 reaches its maximum (FIG. 6) or minimum (FIG. 7) stroke. At intermediate positions (FIG. 8), no potentially damaging forces are encountered. The cylinder 17 is pivotally mounted to the frame 15 at a pivot point 29 which is not coincident with the pivot point 30 of the tongue, but offset in a transverse direction and preferably in a longitudinal direction. The swing cylinder 17 of the present invention preferably strokes at a constant rate, resulting in a variable angular speed, dθ/dt, of the tongue 2 relative to the frame 15. This concept is illustrated in FIG. 5 and in Table 1 for the mower of FIGS. 1-3, where a counterclockwise rotation of the tongue is considered positive, by convention. When the stroking speed, dL/dt, of the swing cylinder 17 is constant, the rotational speed, dθ/dt, of the tongue 2 relative to the frame 15 must be proportional to the derivative, dθ/dL, of the angle, θ, with respect to the cylinder length, L. In other words:

$$\frac{d θ}{d t} = \frac{d θ}{d L} \frac{d L}{d t} = C \frac{d θ}{d L}$$

where C is the constant of proportionality and is equal to the constant stroking speed, dL/dt.

The relationship between the angle, θ, and the cylinder length, L, is:

L(θ)=\sqrt{(B+R cos θ−D sin θ)²+(C+R sin θ+D cos θ)²}

while the derivative of the angle, θ, with respect to the cylinder length, L, is:

$$\frac{d θ}{d L} = \frac{\sqrt{{( B + R cos θ - D sin θ )}^{2} + {( C + R sin θ + D cos θ )}^{2}}}{\begin{matrix}( B + R cos θ - D sin θ ) ( - R sin θ - D cos θ ) + \\ ( C + R sin θ + D cos θ ) ( R cos θ - D sin θ )\end{matrix}}$$

Based on this last equation and the data of Table 1, the rotational speed must increase as the cylinder 17 extends when the swing cylinder's 17 stroke speed is constant. Geometric considerations may accentuate this, or alleviate it. Therefore, it is deemed desirable to have cushioning effects near both extreme ends—both extreme retraction and extreme extension.

TABLE 1

| (+ = CCW) | θ (deg) | L (in) | dθ/dL (deg/in.) |
|---|---|---|---|
| Retracted | 127 | 36.08 | 3.26 |
| Centered | 90 | 46.83 | 3.84 |
| Extended | 53 | 54.62 | 6.49 |

For the values of Table 1, R=40 in, B=16.7 in, C=5.5 in, and D=5.6 in (see FIG. 5.) Full extension is assumed to occur at θ=53° and full retraction when θ=127° (or θ=180−53°). As those of ordinary skill know, the dimensions may be varied without compromising the instant invention.

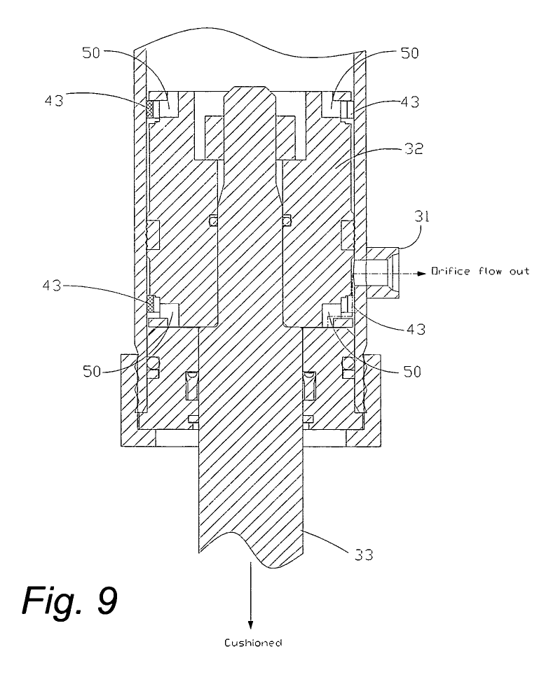

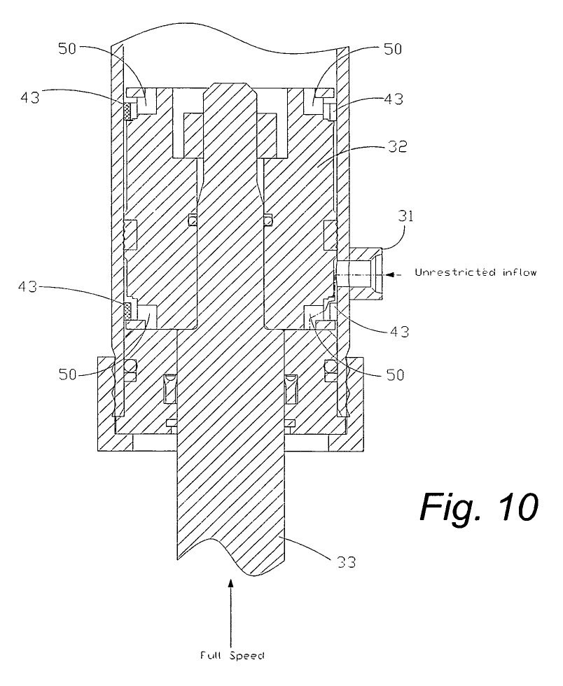

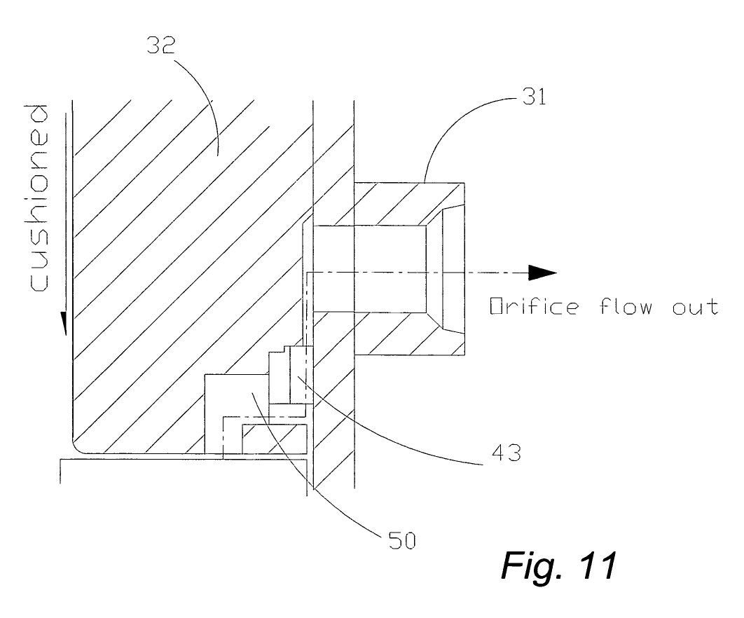

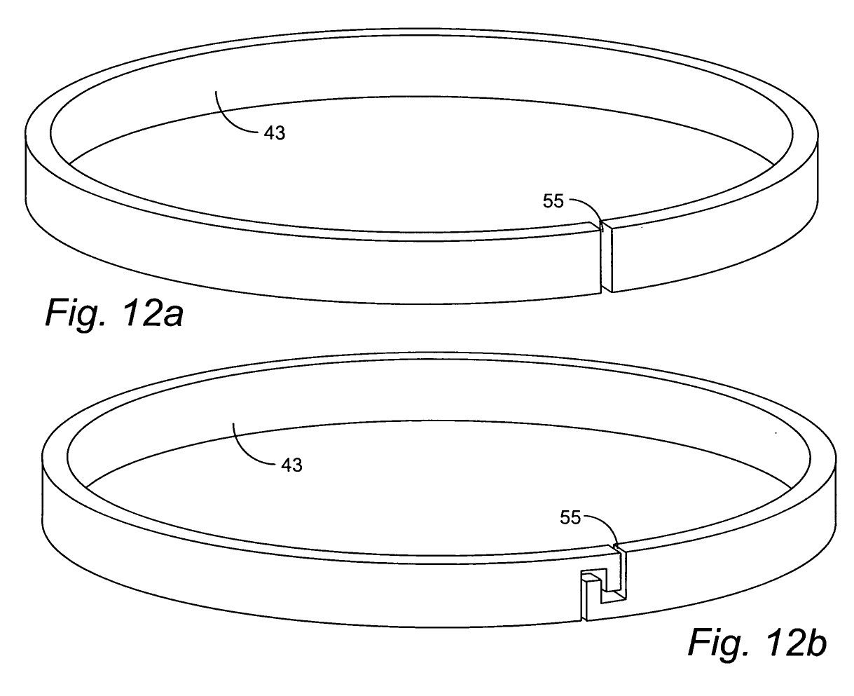

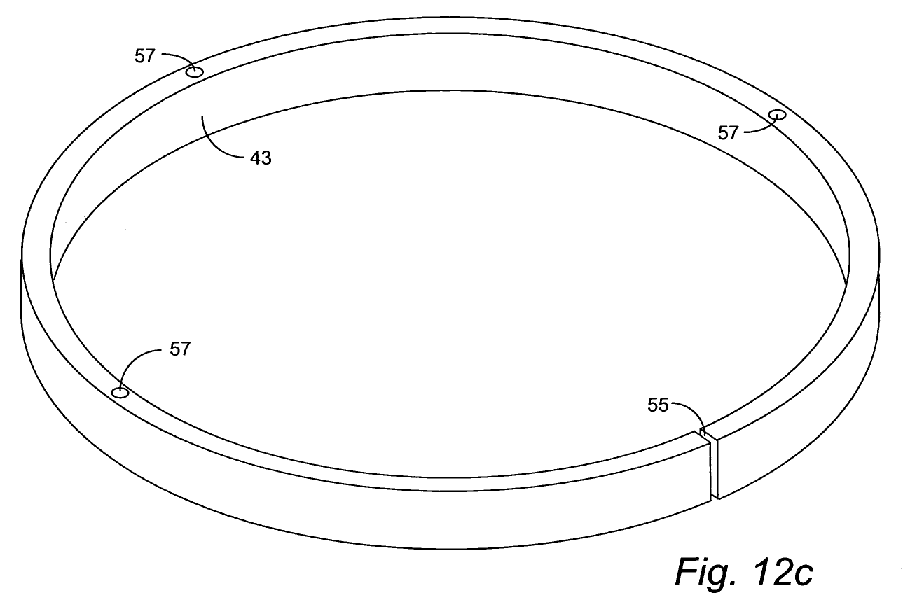

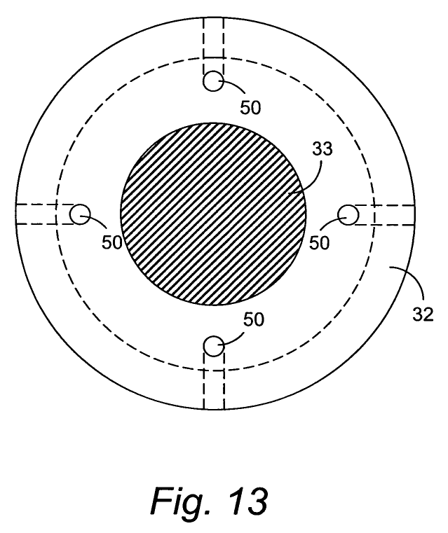

The present invention involves the use of a cushioned cylinder as the swing cylinder 17, which will slow the stroke speed of the cylinder ram 33 as it approaches the extreme ends of the swing cylinder's stroke to decrease dynamic forces and eliminate the problem of structural damage. The cushioning mechanism, most visible in FIGS. 9-11, is a piston 32 surrounding the cylindrical ram 33 such that, as the cylinder ram 33 approaches the extreme retracted or extreme extended position, flow through a port 31 at the associated end becomes increasingly restricted. On either end of the piston 32 there are grooves in which wear rings 43 rest freely. Also on either end of the piston 32, as best seen in FIG. 13, are four passages 50 arranged in a polar array about the central axis of the piston 32 which allow oil to flow from the end of the piston 32 to its side. As the cylinder ram 33 slides toward either extreme position, friction forces the wear ring 43 to the end of its groove in a direction opposite that of travel, as can best be seen in FIG. 11. This wear ring 43 then blocks the path of oil from the passages 50 in the piston 32 to the port 31 as the cylinder ram 33 nears its extreme position. As illustrated in FIGS. 12a-12c, each wear ring 43 has a narrow split 55 in it such that it acts like a temporary, restricting orifice in the port 31. This causes the flow rate of oil to reduce as the piston approaches the extreme position thereby slowing the cylinder ram's 33 travel (see FIG. 9). As illustrated in FIG. 10, when the operator demands the piston 32 leave a given extreme position, the change in oil flow direction causes the wear ring 43 to move out of the way while oil travels through the passages 50 freely to move the piston 32 immediately and with no speed restriction. Therefore, the travel of the piston 32 is cushioned at the extreme retracted and extreme extended ends while the piston 32 experiences full speed motion when leaving the extreme position, as contrasted in FIGS. 9 and 10.

The split 55 in the wear ring 43 may take on a variety of forms. A simple discontinuity in the wear ring 43 is shown in FIG. 12a. A more complex split 55 is shown in FIG. 12b that would disallow the split from widening past a predetermined diameter.

In FIG. 12c, the wear ring 43 possesses axially-oriented orifices 57 to limit the restriction to the flow of hydraulic fluid.

An aspect of the instant invention is the fraction of the swing cylinder's 17 stroke wherein flow is restricted. This fraction is a function of the length of the cylinder ram 33 and the positioning of the working fluid ports 31, as shown in FIGS. 6-8. Positioning the port 31 nearer the extreme end of the hydraulic cylinder 17 results in a lesser fraction of the travel having flow restriction than if the port 31 is placed farther away from the extreme end. The choice of port 31 location depends on the application.

In the present invention, the cushioned portions of the travel on both ends of the cylinder travel have been designed to provide adequate movement and time to decelerate the tongue swing from full speed to the reduced speed, and then to the stopped position at the end of travel. The choice of length of the restricted flow portion of the swing cylinder's 17 stroke is designed to provide adequate time for proper deceleration and minimized to avoid unnecessary delay in the operation of swinging the tongue 2. This restricted portion of travel can vary, but is expected to be within a range of 0.5% to 15% of the overall cylinder stroke at each end of the swing cylinder's 17 stroke. For the preferred embodiment illustrated herein, with the dimensions given above, 5.3% of the full stroke is cushioned on extension and 9.2% of the full stroke is cushioned on retraction. With a nominal full stroke of 19 inches, this translates to 1 inch of restricted travel on the extended stroke and 1.75 inches of restricted travel on the retracted stroke.

It may be clearly seen that other geometries and applications require other values, and the instant invention is not limited to any particular dimensions or percentages.

Note that the application of the instant invention is not limited to an agricultural mower or mower conditioner, nor is the working fluid limited to hydraulic fluid. Any linear actuator 17 with any working fluid in any application may be outfitted with piston 32, sealing ring 60 and wear rings 43 as disclosed herein to reduce the forces occurring when the linear actuator 17 reaches either extreme of its travel.

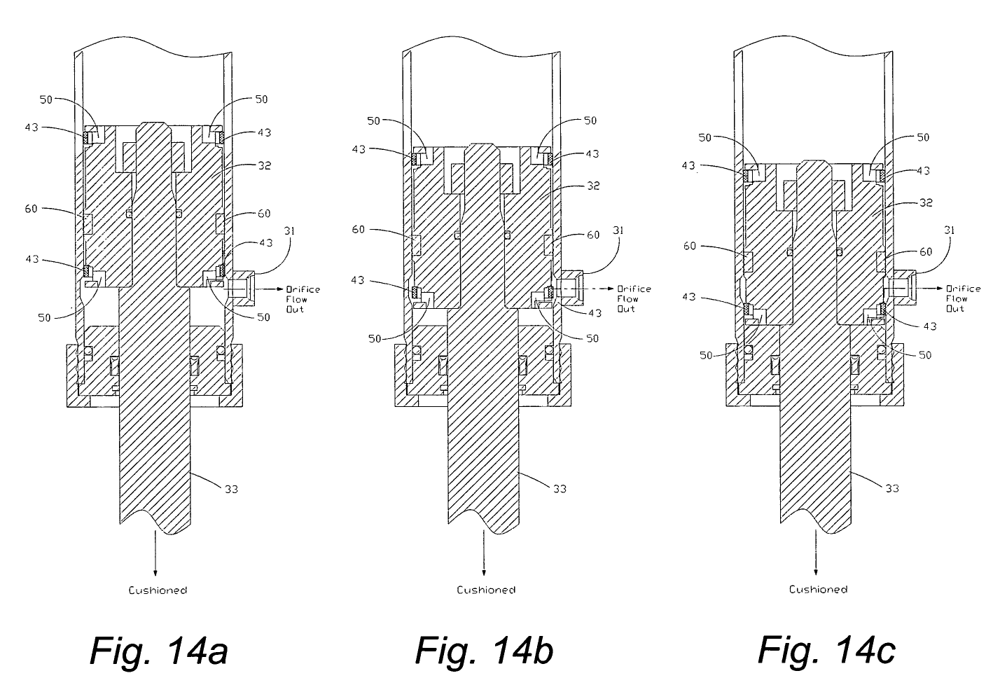

The rate that the wear ring can cushion can be determined by machining the inside diameter of the hydraulic cylinder tube. When the cylinder tube has a uniform inside diameter, the actuator piston starts to slow down as the wear ring begins to close the exit port off to fluid flow. By varying the inside diameter of the hydraulic cylinder, as shown in FIGS. 14a-14c, the rate of piston deceleration is predetermined by the amount of machining done to the tube. Fluid is permitted to flow around the outside diameter of the wear ring until the wear ring nears the extreme edge of the machined area.

The above embodiment is the preferred embodiment, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

1. A method of reducing forces on a tongue and a frame of an agricultural implement when the tongue approaches an extreme angle of travel, the method comprising:
(a) operatively, pivotally attaching the tongue to the frame of the agricultural implement;
(b) operatively, pivotally attaching a first attachment end of a swing actuator to the frame of the agricultural implement, a first attachment point of the first attachment end of a swing actuator to the frame not being coincident with an attachment point of the tongue to the frame;
(c) operatively, pivotally attaching a second attachment end of the swing actuator to the tongue of the agricultural implement, a second attachment point of the second attachment end of a swing actuator to the tongue not being coincident with an attachment point of the tongue to the frame; and
(d) restricting a flow of a working fluid within the swing actuator when the swing actuator nears a first extreme end of a travel of the swing actuator where the tongue nears the first extreme angle of travel of the tongue.

2. The method of claim 1 wherein the tongue also approaches a second extreme angle of travel, different from the first extreme angle of travel, the method additionally comprising restricting the flow of the working fluid within the swing actuator when the swing actuator nears a second extreme end of the travel of the swing actuator where the tongue nears the second extreme angle of travel of the tongue.

3. The method of claim 2 wherein the swing actuator comprises a cylinder, a piston, a cylinder ram, a first wear ring, a second wear ring located nearer the second extreme end of travel than the first wear ring, and an axial direction, and wherein restricting the flow of the working fluid within the swing actuator when the swing actuator nears the first extreme end of the travel of the swing actuator comprises:
(a) operatively, slidably engaging the actuator ram in the actuator cylinder;
(b) operatively engaging the actuator piston to the actuator ram;
(c) providing a at least one fluid passage in the piston through which the working fluid may flow;
(d) forming a first circumferential groove in the piston;
(e) forming a second circumferential groove in the piston nearer the second extreme end of travel of the swing actuator than the first circumferential groove;
(f) operatively engaging the first wear ring in the first circumferential groove in the piston;
(g) operatively engaging the second wear ring in the second circumferential groove in the piston;
(h) permitting the first and second wear rings to move in the axial direction under a frictional force due to axial movement of the actuator ram;
(i) restricting the flow of the working fluid through the at least one fluid passage with the first wear ring due to a first general axial position of the piston near the first extreme end of travel of the swing actuator; and
(j) restricting the flow of the working fluid through the at least one fluid passage with the second wear ring due to a second general axial position of the piston near the second extreme end of travel of the swing actuator.

4. The method of claim 3 wherein restricting working fluid flow through the at least one fluid passage with the first wear ring comprises:
(a) positioning the at least one fluid passage to intersect the first circumferential groove toward a side of the circumferential groove away from the first extreme end of travel of the swing actuator; and
(b) permitting the first wear ring to slide in a direction away from the first extreme end of travel of the swing actuator as the piston travels toward the first extreme end of travel of the swing actuator.

5. The method of claim 3 wherein restricting working fluid flow through the at least one fluid passage with the second wear ring comprises:
(a) positioning the at least one fluid passage to intersect the second circumferential groove toward a side of the circumferential groove away from the second extreme end of travel of the swing actuator; and
(b) permitting the second wear ring to slide in a direction away from the second extreme end of travel of the swing actuator as the actuator ram travels toward the second extreme end of travel of the swing actuator.

6. The method of claim 3 additionally comprising providing a split in the wear ring through which the working fluid may flow.

7. The method of claim 3 wherein providing at least one fluid passage in the piston through which a working fluid may flow comprises providing the at least one fluid passage for the working fluid to flow from the actuator cylinder to an outlet port.

8. The method of claim 3 additionally comprising:
(a) positioning the at least one fluid passage to intersect the first circumferential groove toward a side of the first circumferential groove away from the first extreme end of travel of the swing actuator; and
(b) permitting the first wear ring to slide in a direction toward the first extreme end of travel of the swing actuator as the actuator ram travels away from the first extreme end of the swing actuator travel, thereby unrestricting the working fluid flow through the at least one fluid passage.

9. The method of claim 3 additionally comprising:
(a) positioning the at least one fluid passage to intersect the second circumferential groove toward a side of the second circumferential groove away from the second extreme end of travel of the swing actuator; and
(b) permitting the second wear ring to slide in a direction toward the second extreme end of travel of the swing actuator as the actuator ram travels away from the second extreme end of the swing actuator travel, thereby unrestricting the working fluid flow through the at least one fluid passage.

10. The method of claim 3 additionally comprising:
(a) permitting the working fluid to flow directly from the swing actuator cylinder to a first outlet port near the first extreme end until the wear ring reaches the first outlet port;
(b) blocking the working fluid flow to the first outlet port after the wear ring reaches the first outlet port; and
(c) restricting the flow to the first outlet port to cushion forces due to deceleration of the swing actuator piston after the working fluid flow to the first outlet port is blocked.

11. The method of claim 3 additionally comprising:
(a) permitting the working fluid to flow directly from the swing actuator cylinder to a second outlet port near the second extreme end until the wear ring reaches the second outlet port;
(b) blocking the working fluid flow to the second outlet port after the wear ring reaches the second outlet port; and
(c) restricting the flow to the second outlet port to cushion forces due to deceleration of the swing actuator piston after the working fluid flow to the second outlet port is blocked.

12. An apparatus for actuation and reducing forces on an agricultural implement, the apparatus comprising:
an agricultural implement tongue for drawing the agricultural implement using a prime mover, said agricultural implement tongue having a first extreme angle of travel and a second extreme angle of travel;
an agricultural implement frame, operatively, pivotally attached to said agricultural implement tongue;
a swing actuator comprising:
(a) a first attachment end, operatively, pivotally attached to the agricultural implement frame;
(b) a second attachment end, operatively, pivotally attached to the tongue of the agricultural implement; and
(c) a first flow restrictor within the swing actuator for restricting a flow of a working fluid when the swing actuator nears a first extreme end of a travel of the swing actuator where the tongue nears the first extreme angle of travel of the tongue, said first flow restrictor made to cause the swing actuator to decelerate.

13. The apparatus of claim 12 additionally comprising a second flow restrictor within the swing actuator for restricting a flow of the working fluid when the swing actuator nears a second extreme end of the travel of the swing actuator where the tongue nears the second extreme angle of travel of the tongue, said second flow restrictor made to cause the swing actuator to decelerate.

14. The apparatus of claim 13 wherein the swing actuator further comprises:
(a) an actuator cylinder;
(b) an actuator ram operatively, slidably engaged in the actuator cylinder;
(c) a piston, operatively engaged to the actuator ram;
(d) at least one fluid passage formed in the actuator piston through which the working fluid may flow;
(e) a first circumferential groove formed in the actuator piston;
(f) a second circumferential groove formed in the actuator piston nearer the second extreme end of travel of the swing actuator than the first circumferential groove;
(g) a first wear ring operatively engaged in the first circumferential groove in the actuator piston such that the first wear ring may move axially in the first circumferential groove under a frictional force, said axial movement to block or restrict the flow of the working fluid through the at least one fluid passage with the first wear ring; and
(h) a second wear ring operatively engaged in the second circumferential groove in the actuator piston such that the second wear ring may move axially in the second circumferential groove under a frictional force, said axial movement to block or restrict the flow of the working fluid through the at least one fluid passage with the second wear ring.

15. The apparatus of claim 14 wherein the swing actuator further comprises:
(a) a split in the first wear ring through which the working fluid may flow; and
(b) a split in the second wear ring through which the working fluid may flow.
(c) Any path that restricted fluid can flow through and/or around the wear rings.

16. The apparatus of claim 14 wherein the swing actuator further comprises:
(a) a first port disposed a predetermined distance from the first extreme end of the travel of the swing actuator; and
(b) a second port disposed a predetermined distance from the second extreme end of the travel of the swing actuator.

17. The method of claim 10 wherein restricting the flow to the first outlet port comprises restricting at a varying rate as the actuator piston moves past the first outlet port.

18. The method of claim 17 comprising varying the inside diameter of the actuator cylinder to vary a flow rate of fluid passing around the outside diameter of the wear ring.

19. The method of claim 17 comprising varying the inside diameter of the actuator cylinder to vary the width of the split of the wear ring thereby varying an amount of restriction.
